(19) United States
(12) Patent Application Publication
(10) Pub. No.: US 2007/0032994 A1
(43) Pub. Date: Feb. 8, 2007

(54) System and method of flow assurance in a well

(76) Inventors: Stephen J. Kimminau, Sudbury (GB); John Ratulowski, Missouri City, TX (US); Mohammed T. Rupawalla, Sugar Land, TX (US)

Correspondence Address: SENSOR HIGHWAY LIMITED, GAMMA HOUSE, ENTERPRISE ROAD, CHILWORTH SCIENCE PARK, SOUTHAMPTON, HAMPSHIRE, 8016 7NS, GB

(21) Appl. No.: 11/195,416

(22) Filed: Aug. 2, 2005

(51) Int. Cl. G06G 7/48

(52) U.S. Cl. 703/10

(57) ABSTRACT

A system and method is provided for assuring adequate flow in one or more wells. The system and method utilize a sensor system and a modeling technique that provides simple outputs readily usable by a non-specialist wellbore operator.

### BACKGROUND OF THE INVENTION

1. Field of the Invention

The present invention relates to a system and method for assuring maintenance of desirable flow in a well or group of wells.

2. Description of Related Art

Petroleum fluids or other fluids are produced from a variety of wells. The fluids flow through pipework or tubing that can be subject to a range of physical and chemical conditions which detrimentally impact or even stop flow. For example, flow may be restricted or stopped by the formation of solid hydrates or the deposition of waxes, asphaltenes, or inorganic scale. The deposition of these materials within the tubing decreases the production rate and/or requires costly flow remediation techniques.

Specialists are used to evaluate well properties and physical properties of the produced fluids. These properties are evaluated by the specialists with various well related tools to determine the well conditions likely to create reductions in flow. For example, in a typical application, fluid samples are taken and analyzed by specialists in laboratories to determine the physical conditions under which hydrate formation or wax or asphaltene deposition will occur. Using this data and flow models of the complete production system under a wide range of operating conditions, flow assurance specialists may create operating guidelines which depend on measured flow conditions. These guidelines will either be general and very conservative, or they will require frequent manual adjustment. Furthermore, the specialists having such specialized skills and expertise are in short supply.

### BRIEF SUMMARY OF THE INVENTION

In general, the present invention provides a system and method for assuring flow in a well or wells. The methodology and system utilize a flow system model into which real-time data is input. The real-time data is obtained from sensors deployed along the pipework through which well fluids are produced. For example, temperature data may be obtained from fiber optic distributed temperature sensors, and pressure data may be obtained from a plurality of pressure sensors deployed along the pipework. The real-time data is automatically utilized by the flow system model to determine whether well conditions fall within desirable, predetermined ranges for satisfactory flow assurance. If not, a readily interpretable indicator/warning is output for observation by a non-specialist production operator. This enables the operator to make adjustments to the well to assure well parameters remain within optimal ranges, thereby maintaining operation of the well and the desired flow of production fluids.

### BRIEF DESCRIPTION OF THE DRAWINGS

Certain embodiments of the invention will hereafter be described with reference to the accompanying drawings, wherein like reference numerals denote like elements, and:

FIG. 1 is an elevation view of a well system, according to an embodiment of the present invention;

FIG. 2 is an elevation view of another embodiment of the system illustrated in FIG. 1, according to an embodiment of the present invention;

FIG. 3 is a cross-sectional view of a fluid production pipe that may be utilized with the systems illustrated in FIGS. 1 and 2, but showing deposition of materials that inhibit flow therethrough;

FIG. 4 is a flowchart generally representing an embodiment of the methodology used in assuring desired flow in a well, according to an embodiment of the present invention;

FIG. 5 is a schematic representation of a control system utilized in collecting data from the well or wells and applying that data to the flow assurance model, according to an embodiment of the present invention;

FIG. 6 is a schematic representation of a plurality of sensors that may be utilized in a given well or wells to obtain data used in a flow system model, according to an embodiment of the present invention;

FIG. 7 is a schematic representation of a control system coupled to sensors in a plurality of wells, according to an embodiment of the present invention;

FIG. 8 is a flowchart generally representing an embodiment of the methodology used in developing specific flow system models for individual wells, according to an embodiment of the present invention;

FIG. 9 is a graphical representation of information predetermined according to the flow system model and stored in the control system illustrated in FIG. 5;

FIG. 10 is another graphical representation similar to that illustrated in FIG. 9;

FIG. 11 is another graphical representation similar to that illustrated in FIG. 9;

FIG. 12 is a flowchart generally representing an embodiment of the methodology for utilizing a flow system model, according to an embodiment of the present invention; and

FIG. 13 is a flowchart generally representing an embodiment of the methodology used in predicting when well conditions will move outside of an optimal range due to, for example, a transient event.

### DETAILED DESCRIPTION OF THE INVENTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to a system and method for assuring flow in wells. The system and method enable the monitoring and control of one or multiple wells by a non-specialist production operator. A flow/production system model is developed according to the specific well or wells of a given project. The model is loaded on a processor system which also receives data, typically in real time, from each well being monitored. The flow system model provides easy to understand warnings or other output to the well operator when sensed well parameters indicate restriction to flow or the potential onset of restriction to flow.

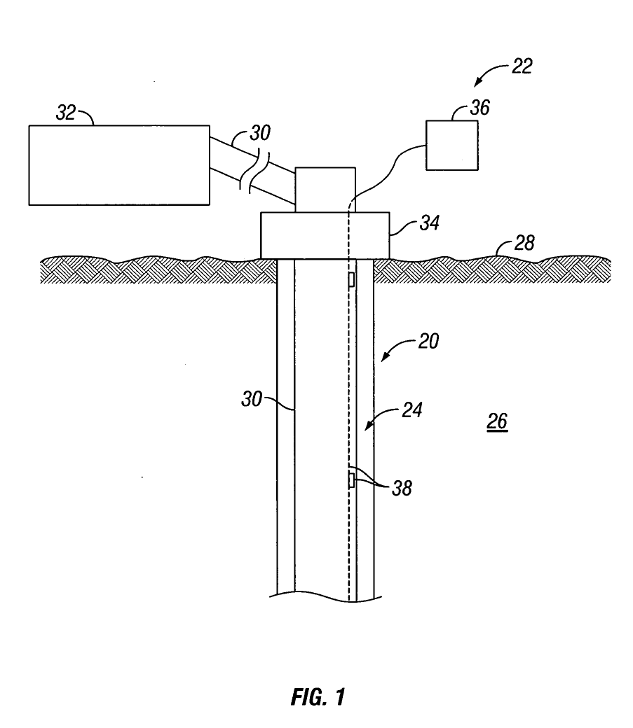

Referring generally to FIG. 1, an example of at least one well 20 is illustrated in combination with a flow assurance system 22. Well 20 comprises a wellbore 24 drilled into an earth formation 26. Wellbore 24 extends downwardly from a surface 28, which may be a land surface or a subsea surface. A tubing 30 extends into wellbore 24 and has a hollow interior for carrying produced fluids, such as petroleum fluids, to a collection location 32. Tubing 30 may include a variety of pipework for carrying produced fluids through wellbore 24 to a wellhead 34, and from wellhead 34 through a variety of land-based or subsea environments to collection location 32.

Flow assurance system 22 comprises a control system 36 operatively coupled to a sensor system 38 deployed along well 20. By way of example, sensor system 38 may comprise a variety of sensors designed to measure well and fluid physical properties. At least some of the sensors may be deployed along or within tubing 30 to detect certain parameters of the fluid being produced.

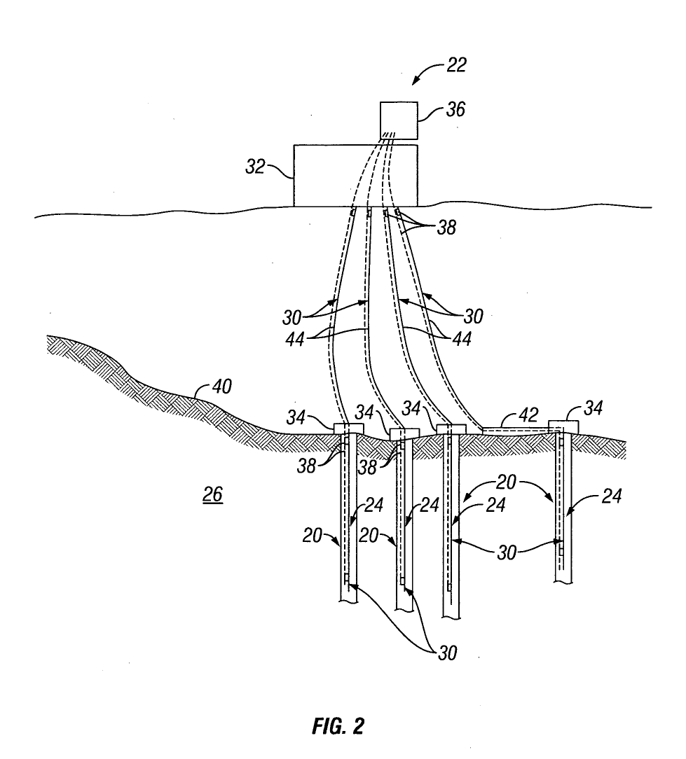

As illustrated in FIG. 2, flow assurance system 22 is adaptable to a variety of environments, and is particularly amenable to subsea project applications with multiple wells. Subsea project applications are susceptible to problems with flow due to, for example, the changes in temperature along the tubing through which the production fluid is produced. The changes in temperature, particularly flow through areas of lower temperature, can accelerate the deposition of undesirable substances.

In the embodiment illustrated in FIG. 2, a plurality of wells 20 are formed in a seabed floor 40 and extend into the subsea formation 26 from a plurality of wellheads 34. In each well 20, tubing 30 extends downwardly into the wellbore from the corresponding wellhead 34 to conduct produced fluids, such as petroleum fluids and brines, upwardly through the wellhead. For each well, tubing 30 extends upwardly beyond the wellhead 34 through a variety of other pipework, including, for example, manifolds, flow lines 42 and risers 44. The fluid from each well is delivered through this tubing to the collection location 32, which may be a topside facility, such as a ship or more permanent facility. In this embodiment, flow assurance system 22 again comprises sensor system 38 with unique sensors deployed along the tubing 30 for each well. The sensor system 38 is coupled to control system 36 which monitors the well and flow related parameters for each individual well. Control system 36 is able to output a simple indication, e.g. warning signal, in the event well related parameters for a given well 20 move or are moving outside of an optimal operating range.

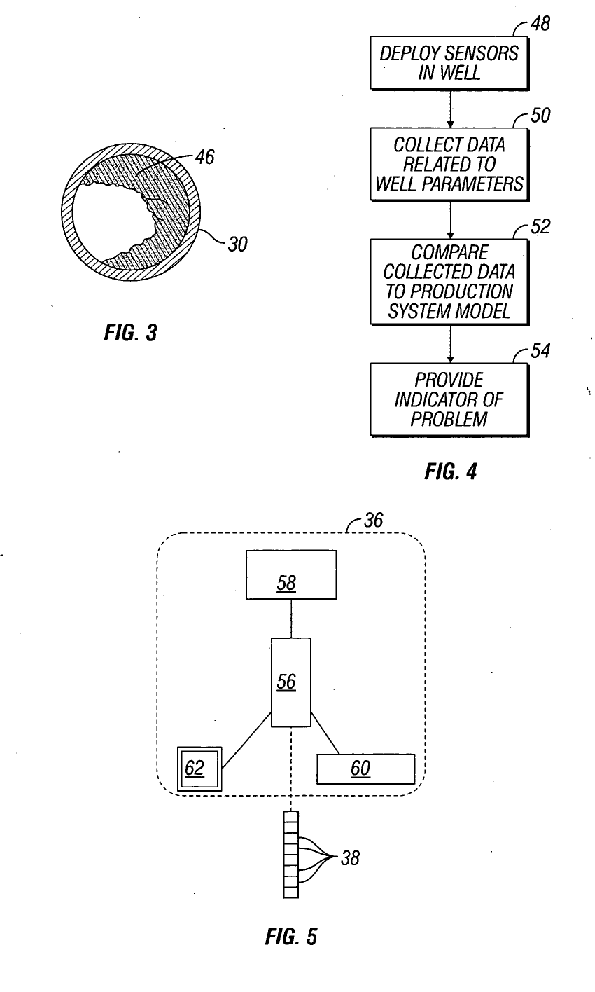

If flow conditions in a given well deteriorate, deposits 46 can begin to form along the interior of sections of tubing 30, as illustrated in FIG. 3. As discussed above, many production environments are susceptible to deposition of hydrates, waxes, asphaltenes, and/or inorganic scale if the well conditions are not carefully monitored and controlled, such as by chemical injection, to assure minimal deposition and desirable flow. Many environmental conditions can contribute to the deposition of these undesirable materials, such as the cold water of deep-sea applications, the co-mingling of incompatible fluids, and/or relatively large pressure drops. Accordingly, different production environments and production techniques can create unique circumstances for deposition of these materials. The well environment, the production techniques, and the equipment utilized affect the flow/production system modeling for each well as described more fully below.

Referring generally to FIG. 4, an example of the methodology associated with the present invention is illustrated in flowchart form. During operation of the well or wells, the methodology enables assurance of sustained and desirable flow through the pipework associated with each well. In general, the methodology involves initially deploying sensors in each well, as represented by block 48. The sensors enable the collection of data related to well conditions that affect flow through the tubing, as illustrated by block 50. This collected data is compared to a production/flow system model that has been designed by a flow specialist for each well based on the numerous factors that can affect flow, including, for example, environment, production techniques, production equipment, and formation constituents, as illustrated by block 52. If the collected data falls outside of an optimal range or ranges as established by the flow system model, an indication, such as a warning, is output to an operator, as illustrated by block 54. The flow system model can also be designed as a predictive model in which an indication, such as a warning, is provided to the operator in the event well conditions are changing and moving towards conditions outside the optimal range. For example, the data collected from the sensor system deployed in a given well may be changing due to a variety of transient events, such as a temporary well production stoppage. The rate at which the sensed conditions are changing can be used by the model to provide an indication as to when those conditions will be outside of the optimal operating range.

The collection of data from sensor system 38 and the application of that data to the flow system model is achieved by control system 36, which may be an automated system as diagrammatically illustrated in FIG. 5. In this embodiment, automated system 36 is a computer-based system having a central processing unit (CPU) 56. CPU 56 may be operatively coupled to sensor system 38, a memory 58, an input device 60 and an output device 62. Input device 60 may comprise a variety of devices, such as a keyboard, mouse, voice-recognition unit, touchscreen, other input devices, or combinations of such devices. Output device 62 may comprise a visual and/or audio output device, such as a console or monitor having a graphical user interface. Additionally, the processing may be done on a single device or multiple devices at the well location, away from the well location, or with some devices located at the well and other devices located remotely.

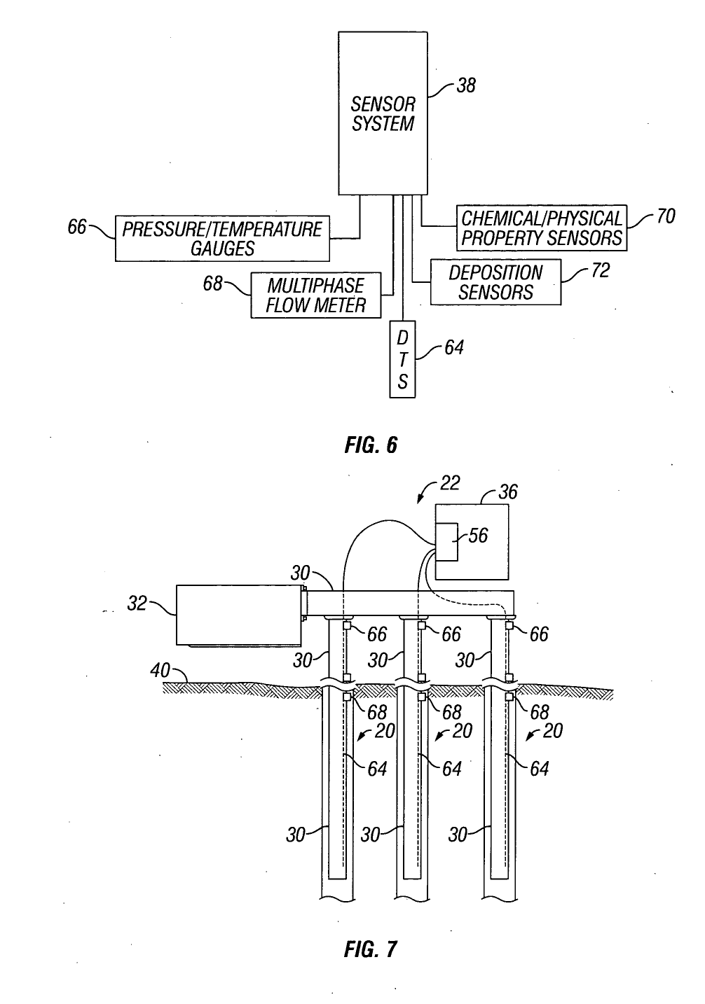

Automated control system 36 is coupled to sensor system 38 to collect data on an ongoing basis. In many applications, some or all of the sensor data is delivered to control system 36 on a real-time basis. Depending on the specific environment and application, a variety of different types of sensors may be coupled to control system 36 to provide the real-time data indicative of conditions that affect flow through tubing 30. As illustrated in FIG. 6, sensor system 38 may comprise distributed temperature sensors 64, pressure and/or temperature gauges 66, multiphase flow meters 68, chemical/physical property sensors 70 and deposition sensors 72. The sensors can be deployed throughout the well and production system. For example, fiber-optic distributed temperature sensors enable the continuous measurement of temperature along a portion or all of the potentially complex network of flow lines, risers, and other pipework of each well. Distributed temperature sensors can be deployed in each well of a multiwell project, and those sensors can be coupled collectively to control system 36. The processor based control system 36 is able to handle the potentially large data rates generated from each distributed temperature sensor. Additionally, point temperature sensors and pressure sensors also can be located in each well and coupled to control system 36 for providing additional ongoing data in real-time. Similarly, accurate multiphase flow meters may be placed at subsurface, subsea, or topside locations in a subsea project application to measure fluid properties simultaneously with flow rates. The multiphase flow meters can be used, for example, to sample flow rates of oil, water, or gas in the well system.

With reference to FIG. 7, an example of multiple types of sensors deployed in multiple wells on a well project is illustrated. In this example, tubing 30 is deployed in each well 20 and delivers fluid from each well to the desired collection location 32. Sensors are deployed along the tubing to collect data on a real-time basis for analysis by the flow system model to insure conditions remain in optimal ranges for continued optimal flow. In this example, a distributed temperature sensing system 64 is deployed along the tubing for each well, both in the wellbore and along the sections of tubing delivering the fluid from the wellbore to the collection location 32, e.g. along flowlines and risers. Pressure sensors 66 also are deployed along the tubing 30 at, for example, flowline and/or riser inlets and outlets, as illustrated. Other sensors, such as multiphase flow meters 68, can be positioned along the pipework to measure physical properties and/or flow rates at specific points along the flow path. The data generated in real-time by the sensors is output to control system 36 for processing according to the flow/production system model. The effective use of the sensor data for flow assurance involves real-time, continuous monitoring and the ability to provide an indication, e.g. warning, to the non-specialist operator at output device 62, e.g. the operator's control console. Additionally, the control system enables the receipt and processing of large amounts of data from the multiple sensors. In a given application, for example, data from the distributed temperature sensors may be collected in real-time every 5-10 minutes. Simultaneously, well pressures, flow rates and other well parameters may be rapidly sampled in real-time, e.g. every 5-10 minutes. Of course, other applications may utilize other sampling rates, including more rapid sampling rates.

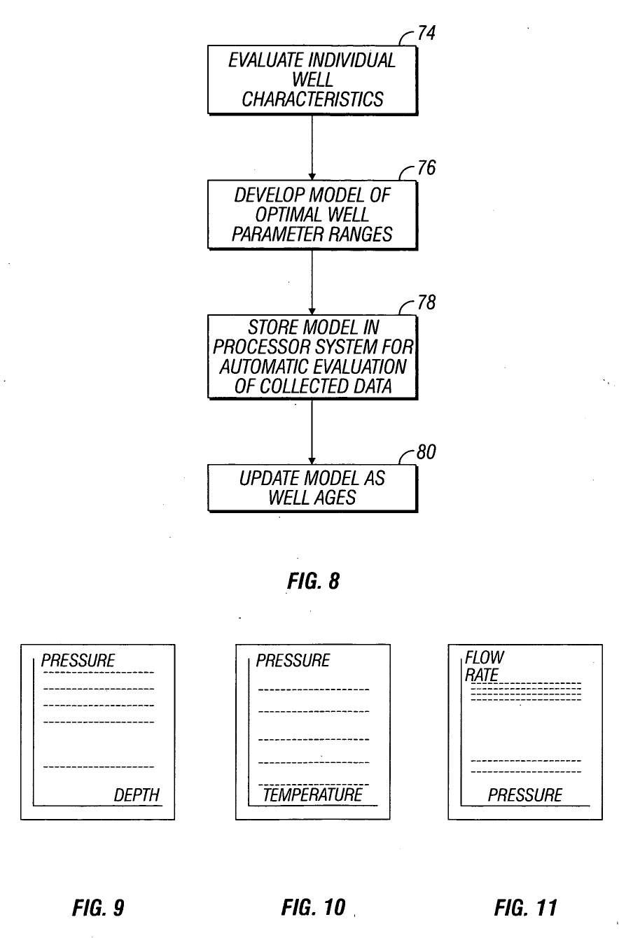

The automated analysis of collected data to insure desired flow through the system tubing requires the development of a flow/production system model that can be utilized on control system 36. As illustrated in FIG. 8, proper modeling requires evaluation of individual well characteristics, as illustrated by block 74. The well characteristics will vary depending on the location and construction of the well project. Examples of well characteristics of interest, include formation pressures, material constituents of the formation, and fluid properties as determined from fluid samples. With an understanding of the well characteristics and production system characteristics, a specialist can develop a production system model that provides optimal well parameter ranges, as illustrated by block 76. Development of the model is aided by a variety of tools available to the specialist, including fluid property models and process models that can be used to assimilate characteristics of a specific well in producing an overall production system model that operates under steady-state conditions and/or transient conditions. Examples of such available tools comprise fluid property modeling techniques, including thermal models, multiphase flow models and deposition models. Additionally, the specialist can utilize process models, such as PIPESIM™ from Schlumberger, for steady-state flow modeling, or OLGA™ from Scandpower Petroleum Technology, for transient flow line simulation. Other examples of tools available to the specialist that may be used to construct the overall flow/production system model include HYSYS® from Aspen Technology, Inc., and Pro/II™ from Simsci-Esscor, a unit of Invensys Systems, Inc., for facilities simulation, WellCat™ from Halliburton, and Prosper™ from Petroleum Experts, for wellbore simulation, and PVTPro™ for correlations for wax content, cloud point, pour point, and viscosities, and PVTi™, for pressure-volume-temperature analysis, both from Schlumberger. The ultimate production model developed by the specialist for a specific well or well project is stored on control system 36 at, for example, memory 58 or another storage location that is either local to the well project or at a remote storage, as illustrated by block 78. It should be noted, however, that as production from a given well continues and the well ages, various characteristics of the well may change. Accordingly, the production/flow system model can be periodically updated, as illustrated by block 80.

The production system model is used to determine the optimal ranges, e.g. temperature ranges or pressure ranges at specific depths in a given well, to assure optimal flow through the tubing. The optimal ranges can be stored by, for example, control system 36 in a variety of ways. In one embodiment, however, the production system model is used to create a set of look-up tables of pressure, temperature, and other flow data that correspond to operating conditions that either require or do not require an indication, e.g. warning, to the operator. In one example, the look-up tables are input to a small software application that runs continuously in the operations environment and monitors relevant sensor data, such as flow line and riser input and output pressures, as well as temperatures obtained from the distributed temperature sensor and/or specific point temperature sensors. This portion of the overall production system modeling technique continuously matches measured inputs obtained from the real-time sensors with the previously stored set of look-up tables and provides a monitoring output to output device 62 for observation by the well operator. The output may be through a graphical user interface that shows whether flow conditions are satisfactory and/or provides warning of flow inhibiting conditions requiring action. The simple output indicators require no operator intervention or specialist knowledge.

Examples of look-up tables are illustrated in FIGS. 9-11. For example, each well in a well project may have a look-up table that contains the optimal range of pressure versus depth of the well, as illustrated in FIG. 9. Each well also may have a look-up table that provides the optimal pressures relative to temperature at specific locations in the well, as illustrated in FIG. 10. Another example of a potentially useful look-up table is illustrated in FIG. 11, in which the optimal range of flow rate versus pressure in the well is provided. Other types of look-up tables can also be generated for various well characteristics of a specific well or group of wells. The use of these predetermined, stored optimal ranges enables the continuous comparison of conditions sensed in real-time by sensor system 38 with the optimal ranges generated by the flow/production system model to assure a continued, desirable flow from each well without the intervention of a specialist.

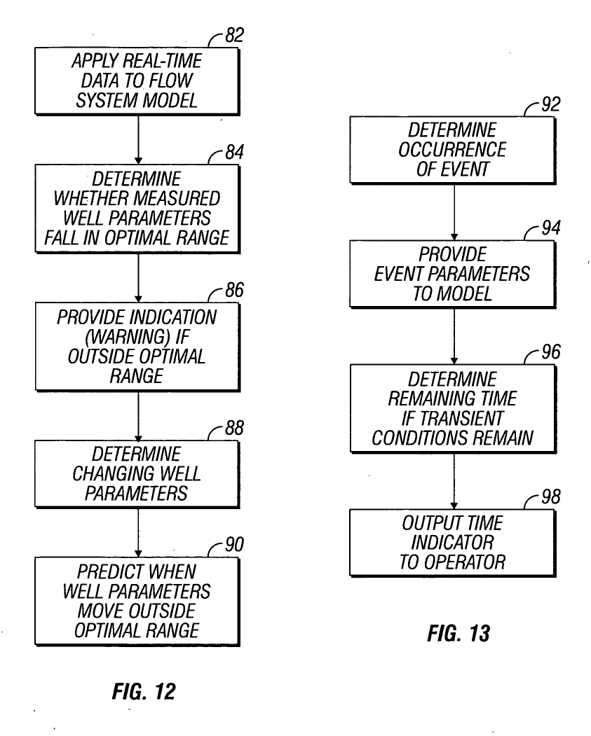

An example of the utilization of the flow/production system modeling is illustrated in FIG. 12. Initially, the real-time data is collected by control system 36, as indicated by block 82. This data can be collected from multiple wells and from along the pipework associated with each of those wells. The collected data is compared with predetermined optimal ranges stored at a location accessible to control system 36, as illustrated by block 84. This enables the model to automatically determine whether the current well parameters fall within the predetermined optimal ranges that will assure desirable flow from each well 20 to the collection location 32. If the collected data corresponding to measured well parameters falls outside an optimal range, an appropriate indication is provided to the production operator, as illustrated by block 86. In one embodiment, a warning is provided to output device 62, e.g. a computer monitor, for the specific well or wells experiencing the problematic condition. Because the well and flow related parameters are measured in real-time, the flow/production system model can be used to monitor changing parameters, as illustrated by block 88. Parameter values can change gradually over time, or they can change relatively rapidly due to, for example, transient events, such as the temporary shutdown of production in a well. Depending on such factors as the specific parameter undergoing change and the rate of change, the modeling technique enables a prediction as to when the well parameters will move outside of a given optimal range, as illustrated by block 90. An indicator can be provided to the operator to give advance warning of the potential for movement of well parameters into a range detrimental to flow. For example, a graphical user interface can be used to provide the operator with a simple predictive timeline illustrating when the well can be expected to move into a suboptimal operating range, e.g. a range susceptible to deposition of undesirable materials on the interior of tubing 30.

Referring generally to FIG. 13, an example of a methodology that may be used by the production system model to predict suboptimal operating ranges is illustrated. In this embodiment, a specific event, such as a transient event, is initially determined, as illustrated by block 92. The transient event, e.g. temporary production shutdown, can be manually input to the production system model via input device 60, or it can be determined from an appropriate sensor, such as a pressure sensor or flow meter sensor positioned at an outlet of tubing 30. During the event, the wellbore parameters are continuously monitored by sensor system 38 in real-time, and that data is fed to control system 36 in the production system model, as illustrated by block 94. Based on these parameters, the type of transient event, and the real-time rate of change in these parameters, the system model can predict the remaining time for maintaining optimal flow parameters if the transient conditions are not changed, as illustrated by block 96. In other words, under the transient conditions, no flow impairment may yet have occurred, but further parameter changes, such as continued cooling or changes in pressure, will bring the well or wells into a suboptimal state. The predictive indicator is output to an operator, as illustrated by block 98. This indicator can be output to the operator in a variety of ways, including graphically, audibly, linguistically or by a variety of other output indicators readily understood by the production operator.

Accordingly, the modeling technique described above provides an integrated software system that utilizes predetermined flow system modeling and real-time inputs from sensors deployed in the well project to provide a remote, real-time, continuous monitoring and warning system for a non-specialist production operator. The use of this modeling technique also enables the monitoring of many projects simultaneously and ensures that the individual wells operate under optimum conditions to increase flow rate and minimize downtime. The modeling technique and real-time monitoring of ongoing well conditions further provides predictive capabilities that enable the production operator to determine if a given well or wells is moving towards a suboptimal operating range that will have a detrimental effect on flow.

Although, only a few embodiments of the present invention have been described in detail above, those of ordinary skill in the art will readily appreciate that many modifications are possible without materially departing from the teachings of this invention. Accordingly, such modifications are intended to be included within the scope of this invention as defined in the claims.

What is claimed is:

1. A method of assuring flow in a well, comprising:
applying a production system model to a well based on characteristics of the well;
collecting data in real-time related to flow conditions of the well;
automatically comparing the collected data to prestored parameters of the production system model to determine if the collected data is outside an optimal range; and
providing an indication to an operator when the collected data falls outside the optimal range.

2. The method as recited in claim 1, further comprising providing a predictive output to the operator as to when well parameters will move outside the optimal range.

3. The method as recited in claim 1, further comprising adjusting the production system model as the well ages.

4. The method recited in claim 1, wherein collecting data comprises collecting temperature data with a distributed temperature sensing system deployed along tubing in the well.

5. The method as recited in claim 1, wherein collecting data comprises collecting data with a multiphase flow meter.

6. The method as recited in claim 1, wherein collecting data comprises measuring flow rates.

7. The method as recited in claim 1, wherein collecting data comprises sampling temperatures along a tubing in the well approximately every 5 to 10 minutes.

8. The method as recited in claim 7, wherein collecting data comprises sampling a well pressure approximately every 5 to 10 minutes.

9. The method as recited in claim 8, wherein collecting data comprises sampling a flow rate through the tubing approximately every 5 to 10 minutes.

10. The method as recited in claim 9, wherein sampling a flow rate comprises sampling an oil flow rate.

11. The method as recited in claim 9, wherein sampling a flow rate comprises sampling a gas flow rate.

12. The method as recited in claim 9, wherein sampling a flow rate comprises sampling a water flow rate.

13. The method as recited in claim 1, wherein automatically comparing comprises comparing the collected data to prestored parameters in look-up tables of a processor-based control system.

14. The method as recited in claim 1, wherein providing an indication to an operator when the collected data falls outside the optimal range comprises displaying information on a graphical user interface.

15. A method of assuring flow of a petroleum fluid from a well through well tubing, comprising:
applying a production system model to a well based on characteristics of the well;
collecting data over time related to ongoing flow conditions of the well; and
utilizing a control system to automatically apply the collected data to the production system model to determine predictions as to when operational well parameters will fall outside an optimal operational range.

16. The method as recited in claim 15, wherein utilizing a control system further comprises automatically comparing the collected data to production system model values prestored in look-up tables.

17. The method as recited in claim 15, further comprising adjusting the production system model as the well ages.

18. The method as recited in claim 15, wherein collecting data comprises collecting temperature and pressure data from the well on a real-time basis.

19. The method as recited in claim 15, wherein applying a production system model comprises applying the production system model to a subsea well.

20. The method as recited in claim 15, wherein collecting data comprises collecting temperature data via a distributed temperature sensor deployed along tubing through which petroleum fluid is produced.

21. A system for assuring flow in a well, comprising:
a plurality of sensors deployed at multiple locations within a plurality of wells, the sensors capable of sensing wellbore parameters on an ongoing basis;
a processor system coupled to the plurality of sensors, the processor system capable of comparing data output by the plurality of sensors over time with stored data of a production system model to determine whether the wellbore parameters for a given well fall within an optimal operational range to assure a desired production flow of well fluid; and
an output device to provide an indicator to a well operator when the wellbore parameters fall outside the optimal operational range.

22. The system as recited in claim 21, wherein the model further provides an output predictive of future movement of the wellbore parameters outside the optimal operational range.

23. The system as recited in claim 21, further comprising a tubing through which the well fluid is produced from the well.

24. The system as recited in claim 23, wherein the plurality of sensors comprise a distributed temperature sensor deployed along the tubing.

25. The system as recited in claim 23, wherein the plurality of sensors comprises a plurality of pressure sensors disposed to sense pressure in the tubing.

26. The system as recited in claim 25, wherein the plurality of pressure sensors comprises an inlet pressure sensor and an outlet pressure sensor.

27. The system as recited in claim 21, wherein the plurality of sensors comprises a multiphase flow meter.

28. The system as recited in claim 21, wherein the stored data of the production system model is stored in at least one look-up table.

29. The system as recited in claim 28, wherein the at least one look-up table comprises values corresponding to a depth index.

30. The system as recited in claim 21, wherein the processor system comprises a computer-based system having a monitor for graphically displaying information to an operator.

31. A method for assuring flow in a plurality of well projects simultaneously, comprising:
collecting real-time data in a processor system, the real-time data being obtained from sensors deployed in a plurality of wells;
utilizing the processor system to compare the real-time data of each well to a well flow system model on a continuous basis; and
outputting an indication to a system operator if the real-time data from any of the plurality of wells indicates undesirable changes in well parameters towards suboptimal flow conditions.

32. The method as recited in claim 31, wherein collecting real-time data comprises collecting data on well parameters and fluid physical property parameters.

33. The method as recited in claim 31, wherein collecting real-time data comprises collecting data from a distributed temperature sensor.

34. The method as recited in claim 32, wherein collecting real-time data comprises collecting data from a plurality of pressure sensors.

35. The method as recited in claim 32, wherein collecting comprises collecting data from a multiphase flow meter.

36. The method as recited in claim 31, wherein utilizing the processor system comprises comparing the real-time data to stored look-up tables.

37. The method as recited in claim 31, wherein outputting an indication to a system operator comprises outputting the indication to a graphical user interface readily understood by a non-specialist operator.
